(19) United States
(12) Patent Application Publication
(10) Pub. No.: US 2018/0049020 A1
(43) Pub. Date: Feb. 15, 2018

(54) SERVER APPARATUS, PROGRAM, DATA TRANSMISSION AND RECEPTION METHOD, AND TERMINAL DEVICE

(71) Applicant: Isao Fujino, Tokyo (JP)

(72) Inventors: Isao Fujino, Tokyo (JP); Koji Okawa, Tokyo (JP); Tomoko Fujino, Tokyo (JP)

(21) Appl. No.: 15/235,207

(22) Filed: Aug. 12, 2016

(51) Int. Cl. H04W 8/18; H04W 12/06; G06Q 30/02; H04L 12/58; G06F 3/14; H04W 4/00; H04W 12/04

(52) U.S. Cl. CPC H04W 8/18; H04W 4/008; H04W 12/06; H04W 12/04; H04L 51/04; G06F 3/14; G06Q 30/0241; H04W 88/02

(57) ABSTRACT

To increase the chance of discovering a person desired by a user. A management server includes a user information table that stores a user name and user information about the user in association with each other, a proximity user table that stores identification information about a portable terminal device carried by a first user and identification information about a terminal device of a second user located in proximity of the first user obtained from short distance communication, each in association with user identification information, an extraction unit that refers to the user information table and the proximity user table and extracts, from the user information table, the user information about the keyword and associated with the user identification information present in the proximity user table when the extraction unit receives a keyword with which a predetermined user is searched from the portable terminal device carried by the first user, and a display unit that causes a display of the portable terminal device carried by the first user to display the extracted user information.

### TECHNICAL FIELD OF THE INVENTION

The present invention relates to a server apparatus, a program, a data transmission and reception method, and a terminal device.

### BACKGROUND OF THE INVENTION

A method to meet and contact a person who is present in a proximity area by using a terminal device such as a mobile phone and a smart phone is known.

For example, an apparatus provided with matching means for performing collation for determining whether, if there is another user at a close location, key data about a person with whom it is desired to meet or contact matches or related to the “key data about the user”, and notification means provided on a computer connected to a mobile communication terminal or network used by the user on the basis of an output from this matching means and notifying, when the matching means determines that there is one in “key data” of both of the user and the other user that match each other or related to each other, the user to that effect is known.

### SUMMARY OF THE INVENTION

In a prior art document, Japanese Patent Application Laid-Open Publication No. 2002-24113, an ID and a name of a person with whom it is desired to meet and talk to when the person is present in proximity by accident, and a hobby club name and an academy name which the person belongs to are recorded in advance. Therefore, when a user suddenly thinks of a keyword and wants to search the keyword, the above prior art document cannot cope with such case.

According to one aspect, it is an object of the present invention to increase the chance of discovering a person desired by a user.

In order to achieve the above object, a server apparatus disclosed herein is provided. This server apparatus includes a first storage unit that stores user identification information and user information about a user in association with each other, a second storage unit that stores identification information about a portable terminal device carried by a first user and identification information about a terminal device of a second user located in proximity to the first user obtained from short distance communication each in association with the user identification information, an extraction unit that refers to the first storage unit and the second storage unit, and extracts, from the first storage unit, user information about a keyword and associated with the user identification information present in the second storage unit when the extraction unit receives the keyword with which a predetermined user is searched from the portable terminal device carried by the first user, and a display unit that causes a display of the portable terminal device carried by the first user to display the extracted user information.

According to one aspect, the chance of discovering a person desired by a user can be increased.

### BRIEF DESCRIPTION OF THE DRAWINGS

FIG. 1 is a figure illustrating a communication support system according to an embodiment;

FIG. 2 is a figure illustrating a hardware configuration of a portable terminal device according to an embodiment;

FIG. 3 is a figure illustrating a hardware configuration of a management server according to an embodiment;

FIG. 4 is a block diagram illustrating functions of a portable terminal device according to an embodiment;

FIG. 5 is a figure for explaining a user profile screen after logging in;

FIG. 6 is a figure for explaining a matching screen;

FIG. 7 is a figure for explaining a chat screen;

FIG. 8 is a block diagram for illustrating functions of a management server;

FIG. 9 is a figure for explaining an authentication information table;

FIG. 10 is a figure for explaining a proximity user table;

FIG. 11 is a figure for explaining a user information table;

FIG. 12 is a figure for explaining a communication table;

FIG. 13 is a flowchart for explaining pre-processing;

FIG. 14 is a flowchart for explaining processing of a portable terminal device according to an embodiment; and

FIG. 15 is a flowchart for explaining matching information generation processing.

### DESCRIPTIONS OF THE PREFERRED EMBODIMENTS

Hereinafter, a communication support system according to an embodiment will be explained in details with reference to drawings.

### Embodiment

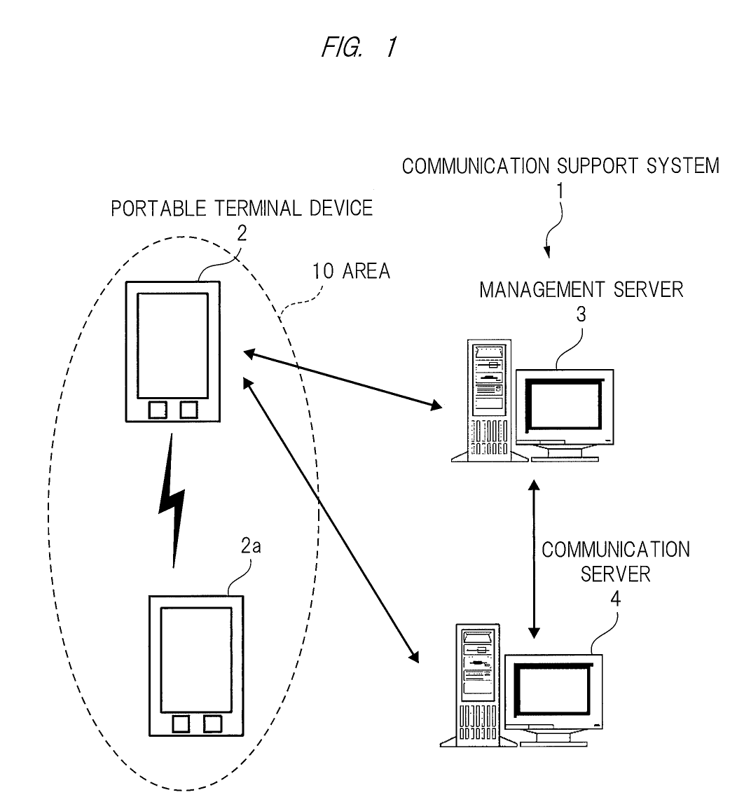

FIG. 1 is a figure illustrating a communication support system according to an embodiment.

The communication support system 1 includes portable terminal devices 2, 2a, a management server (computer) 3 for managing information about a user holding the portable terminal device 2, and a communication server 4 enabling chat and communication between the portable terminal devices 2 and 2a. The portable terminal devices 2, 2a, the management server 3, and the communication server 4 are connected to each other via a network such as the Internet.

The portable terminal devices 2, 2a are located within, for example, an area 10 in which a short distance communication can be performed over about several meters to several dozen meters. Examples of portable terminal devices 2, 2a include a mobile phone, a smart phone, a tablet type terminal device, an audio/video device, toy (a game machine, a robot, a toy controller, and the like), a wearable terminal device, devices for health and medicine (a blood pressure meter, a pulse meter, a thermometer, and the like), and the like. Examples of methods of short distance communication include area search and the like using Bluetooth (registered trademark), Wireless Fidelity (Wi-Fi), and Global Positioning System (GPS) functions. Hereinafter, for example, a case where a short distance communication is performed by using Bluetooth (registered trademark) will be explained.

For example, a user holding the portable terminal device 2 (hereinafter referred to as a user A) logs in an application supporting communication (hereinafter referred to as communication application) by operating the portable terminal device 2. The portable terminal device 2 searches a terminal device located in proximity to the portable terminal device 2 by using the short distance communication. The terminal device referred to herein includes not only the portable terminal device explained above but also a notebook computer, a fixed type installation PC, and the like. Then, the portable terminal device 2 transmits the MAC ID (MAC address) of the found terminal device to the management server 3. A user A inputs, in real time, a keyword for identifying a person with which the user A wants to communicate into the portable terminal device 2 in accordance with a screen displayed on a display of the portable terminal device 2.

The management server 3 searches a user who is carrying a terminal device located in proximity to the portable terminal device 2 and for which the input keyword (or a keyword related to the input keyword) is registered in advance.

In the example as illustrated in FIG. 1, it is assumed that a user who is carrying the portable terminal device 2a (hereinafter referred to as a user B) registers, into the management server 3, a keyword related to the keyword which is input by the user A in advance.

The management server 3 transmits, to the portable terminal device 2, information about the user B such as a profile about the user B. Then, the information about the user B is displayed on the display of the portable terminal device 2.

The user A who is carrying the portable terminal device 2 selects, for example, information displayed on the monitor, so that a message for asking a contact can be sent to the user B. Accordingly, the message for asking the contact is displayed on the display of the portable terminal device 2a.

When the user B wants to contact the user A upon seeing the message sent from the portable terminal device 2, the user B replies messages of “chat OK” and “telephone call OK”.

The management server 3 collates the MAC ID obtained from Bluetooth (registered trademark) with the server information, and when data exists in the management server 3, the management server 3 converts the obtained MAC ID into an account of the Internet.

Accordingly, the user A can communicate with the user B of the portable terminal device 2a via the communication server 4 by operating the portable terminal device 2.

Alternatively, the users who are carrying the portable terminal devices 2, 2a may communicate with each other by using Bluetooth (registered trademark).

According to this communication support system 1, a person with whom communication is to be performed is identified in real time, and a contact can be made with the person.

The location where this communication support system 1 is used is not particularly limited, but examples of places where the communication support system 1 can be used include a space that is not divided by a partition such as a town, a space that is divided by a partition such as a party venue, a train, and an airplane. For example, when a user is in an airplane to San Francisco, the user selects keywords such as “San Francisco guide” and “San Francisco sightseeing”, so that the user can identify other user related to these keywords in real time. The chance of finding a user sought for can be increased in a shorter time by inputting keywords in real time. When a user comes to a town and has a little bit of waiting time, for example, the user can enjoy some chat by inputting a keyword for the purpose of killing time. The communication support system 1 can also be used as means for meeting a person for an appointment.

Hereinafter, processing of the communication support system 1 will be explained in details.

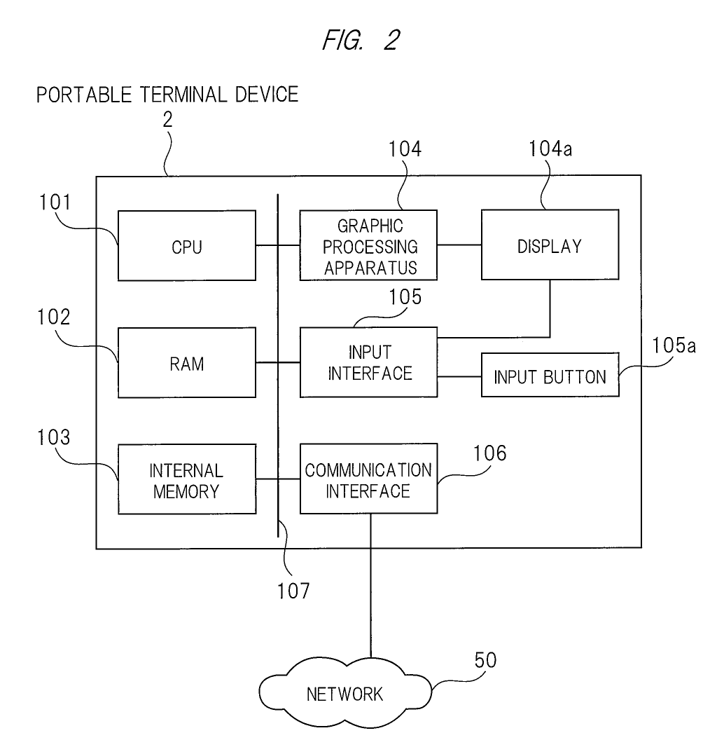

FIG. 2 is a figure illustrating a hardware configuration of a portable terminal device according to an embodiment.

In the portable terminal device 2, a Central Processing Unit (CPU) 101 controls the entire apparatus.

The CPU 101 is connected to a Random Access Memory (RAM) 102 and multiple peripheral devices via a bus 107.

The RAM 102 is used as a main storage device of the portable terminal device 2. The RAM 102 temporarily stores at least some of the programs of an Operating System (OS) and an application program to be executed by the CPU 101. The RAM 102 stores various kinds of data used for the processing with the CPU 101.

The bus 107 is connected to an internal memory 103, a graphic processing apparatus 104, an input interface 105, and a communication interface 106.

The internal memory 103 writes and reads data. The internal memory 103 is used as a secondary storage device of the portable terminal device 2. The internal memory 103 stores programs of the OS, application programs, and various kinds of data. Examples of internal memories include semiconductor storage devices such as a flash memory.

The graphic processing apparatus 104 is connected to a display 104a. The graphic processing apparatus 104 displays an image on a screen of the display 104a in accordance with a command from the CPU 101. The display 104a may be, for example, a liquid crystal display apparatus and the like. The display 104a also includes a touch panel function.

The input interface 105 is connected to a display 104a and an input button 105. The input interface 105 transmits a signal sent from the input button 105a and a touch panel of the display 104a to the CPU 101.

The communication interface 106 is connected to a network 50. The communication interface 106 transmits and receives data to and from other computer or communication device via the network 50.

According to the hardware configuration explained above, the processing functions of the present embodiment can be realized.

FIG. 3 is a figure illustrating a hardware configuration of a management server according to an embodiment.

In the management server 3, a CPU 201 controls the entire apparatus. The CPU 201 is connected to a RAM 202 and multiple peripheral devices via a bus 208. Hereinafter, portions that are different from the portable terminal device 2 will be explained, and portions denotes with the same names will not be explained again since they achieve the same functions.

The bus 208 is connected to a hard disk drive 203, a graphic processing apparatus 204, an input interface 205, a drive apparatus 206, and a communication interface 207.

The hard disk drive 203 magnetically writes and reads data to and from a disk provided therein. The hard disk drive 203 is used as a secondary storage device of the management server 3. The hard disk drive 203 stores programs of the OS, application programs, and various kinds of data. Examples of secondary storage devices include semiconductor storage devices such as a flash memory.

The graphic processing apparatus 204 is connected to a monitor 204a. The graphic processing apparatus 104 displays an image on a screen of the monitor 204a in accordance with a command from the CPU 201. The monitor 204a includes a display apparatus using a Cathode Ray Tube (CRT), a liquid crystal display apparatus, and the like.

The input interface 205 is connected to a keyboard 205a and a mouse 205b. The input interface 205 transmits a signal sent from the keyboard 205a and the mouse 205b to the CPU 201. The mouse 205b is an example of a pointing device. Alternatively, the mouse 205b may be another pointing device. Other examples of pointing devices include a touch panel, a tablet, a touchpad, a trackball, and the like.

For example, the drive apparatus 206 reads data recorded on an optical disk recorded with data so that the data can be read by reflection of light, and reads data recorded on a portable recording medium such as a Universal Serial Bus (USB) memory. In a case where, for example, the drive apparatus 206 is an optical drive apparatus, a laser light and the like is used to read data recorded on the optical disk 300. The optical disk 300 may be Blu-ray (registered trademark), Digital Versatile Disc (DVD), DVD-RAM, Compact Disc Read Only Memory (CD-ROM), CD-Recordable (CD-R)/ReWritable (RW), and the like.

According to the hardware configuration explained above, the processing function according to the present embodiment can be realized. FIG. 3 illustrates the hardware configuration of the management server 3, but the communication server 4 also has the same hardware configuration.

Subsequently, the functions provided in the portable terminal devices 2, 2a will be explained.

The following functions are provided in the portable terminal devices 2, 2a having the hardware configuration as illustrated in FIG. 2.

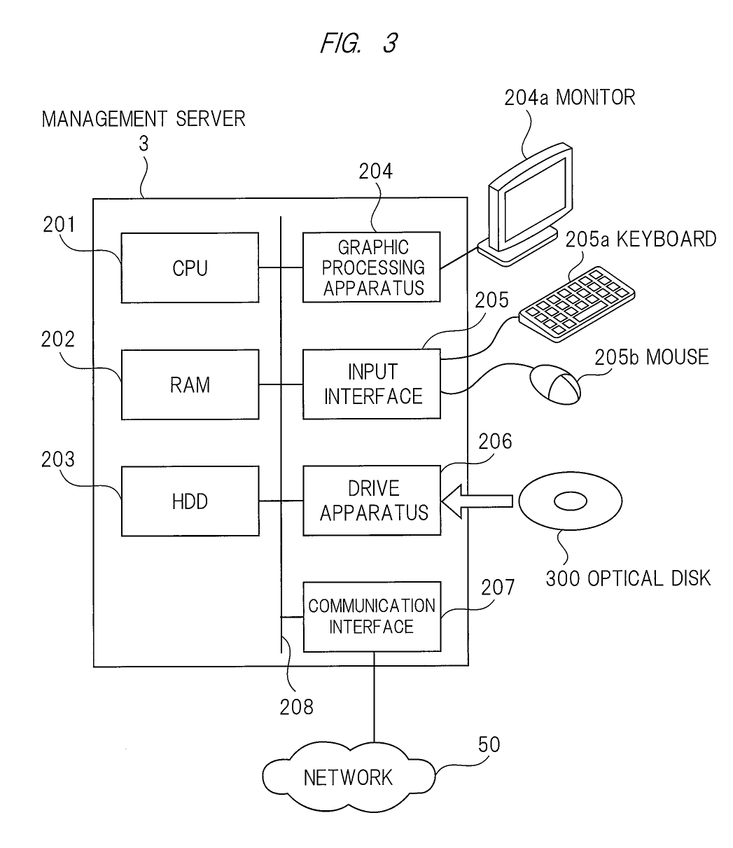

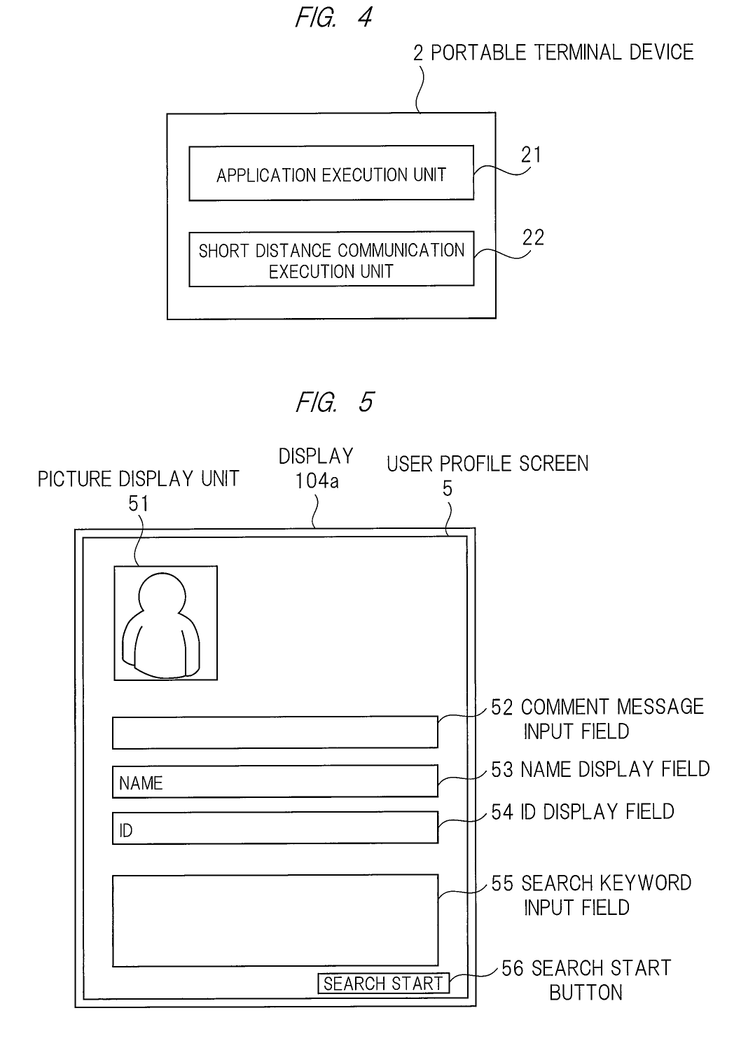

FIG. 4 is a block diagram illustrating the functions of a portable terminal device according to an embodiment.

The portable terminal device 2 includes an application execution unit 21 and a short distance communication execution unit 22.

The application execution unit 21 includes log in-log out functions to log in and log out from a communication application and functions for supporting matching between users. More specifically, the application execution unit 21 displays a user profile screen on the display 104a during log in.

FIG. 5 is a figure for explaining a user profile screen after log in.

The user profile screen 5 is provided with a picture display unit 51, a comment message input field 52, a name display field 53, an ID display field 54, a search keyword input field 55, and a search start button 56.

The picture display unit 51 displays a face picture and the like which is registered in the management server 3 by the user.

In the comment message input field 52, a message and the like can be input to be displayed on a message display unit explained later.

The name display field 53 can display a user name which is registered in the management server 3 by the user.

The ID display field 54 displays the user ID of the user who is logging in to the communication application.

The search keyword input field 55 can input a keyword for searching another user with which communication is to be performed, when the user wants to communicate with the another user who is present in proximity. Examples of search keywords include “believing in Buddhism”, “working for XX Corporation”, “graduating from OO University”, “using SNS”, “living in Hachioji City”, “born in Heisei OO”, and the like. Examples of input methods of a search keyword include a type input method for using a keyword displayed on a screen, an audio input, a braille input, and the like.

The search start button 56 is a button which the user presses down when the user inputs a search keyword.

Again, back to FIG. 4, explanation will be continued.

The short distance communication execution unit 22 obtains the MAC ID of the terminal device present in proximity to the portable terminal device 2 by using Bluetooth (registered trademark).

When the user inputs a search keyword to the search keyword input field 55, and presses down the search start button 56, the application execution unit 21 associates the input search keyword with the user ID and transmits the input search keyword to the management server 3. The management server 3 determines whether a terminal device of a user who matches a condition is present in the proximity of the portable terminal device 2 or not. This determination method will be explained in details later with reference to the flowchart.

In a case where a terminal device of a user who matches the condition is present in the proximity of the portable terminal device 2, the management server 3 transmits information about the user who matches the condition (matching information) to the portable terminal device 2.

The application execution unit 21 displays a matching screen illustrating a list of information about the users who match the condition (hereinafter referred to as “communication candidate”) on the display 104a on the basis of the received matching information.

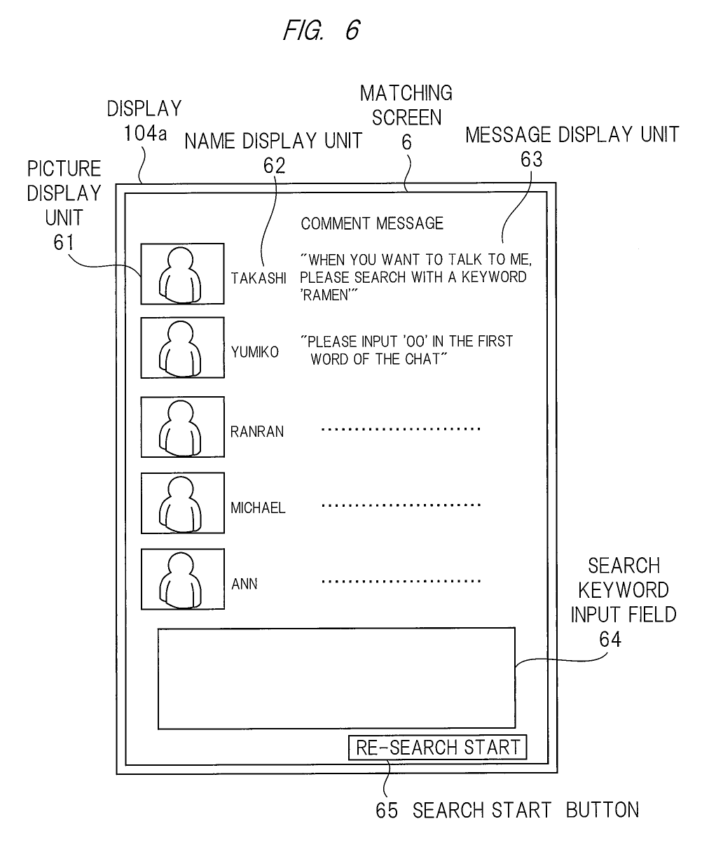

FIG. 6 is a figure for explaining of a matching screen.

The matching screen 6 displays a picture display unit 61, a name display unit 62, and a message display unit 63 for each user of the communication candidate. In a case where a user of the communication candidate cannot be found, for example, a text such as “no user matches the condition” is displayed.

At a lower part of the matching screen 6, a search keyword input field 64 and a re-search button 65 are provided.

The picture display unit 61 displays a face picture and the like of the user of the communication candidate.

The name display unit 62 displays the user name which the user of the communication candidate registered in the management server 3.

The message display unit 63 displays a message which the user of the communication candidate registered in the management server 3 by inputting it to the comment message input field 52. In FIG. 6, for example, message indicating “when you want to talk to me, please search with a keyword ‘Ramen”’ is displayed. As explained later, the user of the communication candidate can find out which keyword is used to access the user. Therefore, the user who sees this message can easily contact with the user of the communication candidate by inputting the keyword “Ramen” in the search keyword input field 55.

In another example, a message indicating that “please input ‘OO’ in the first word of the chat” is displayed. Accordingly, the user who sees this message can easily contact with the user of the communication candidate by inputting “OO” into the first word when chatting with the communication candidate.

When the user selects any one of the picture display unit 61, the name display unit 62, and the message display unit 63 with a tap and the like (receives an appointment request), the application execution unit 21 accesses the communication server 4 to display a chat screen in which a chat with the selected user can be performed on the display 104a.

The functions of the search keyword input field 64 and the re-search start button 65 are the same as the functions of the search keyword input field 55 and the search start button 55, respectively.

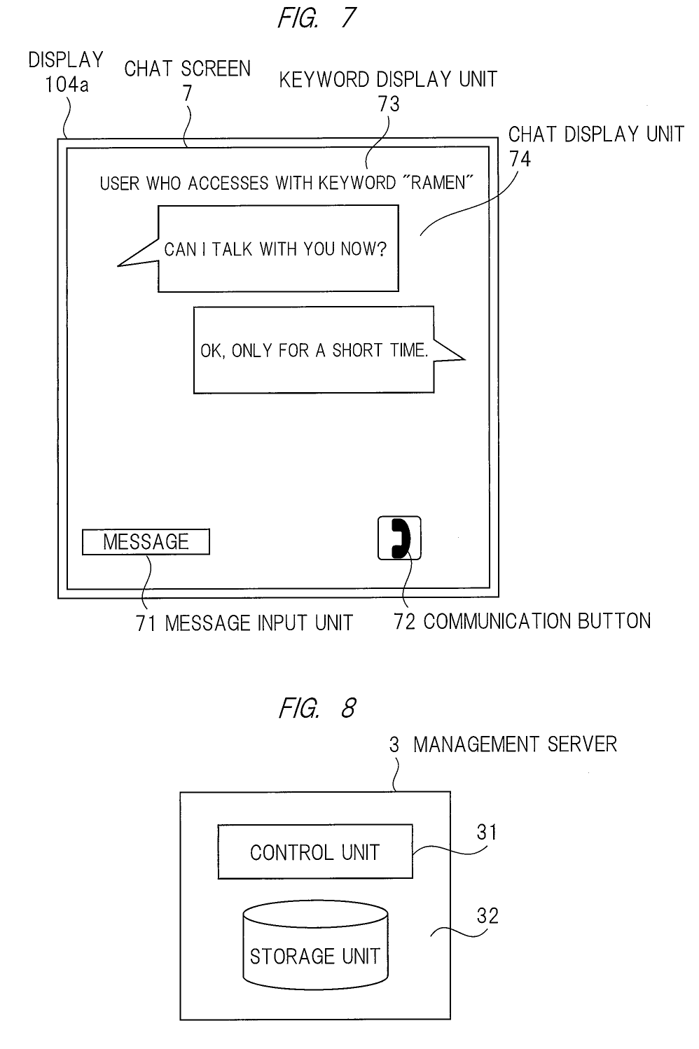

FIG. 7 is a figure for explaining a chat screen.

The chat screen 7 displays a message input unit 71, a communication button 72, a keyword display unit 73, and a chat display unit 74.

The application execution unit 21 displays an input message on the chat display unit 74 when the user inputs a message to the message input unit 71. This message is also displayed on a terminal device with whom a chat is to be performed (a selected user) via the communication server 4.

When a reply is returned from the user, the application execution unit 21 displays the reply content on the chat display unit 74.

Further, the communication server 4 also stores a chat history, and when a chat has already been conducted with the user in the past, the application execution unit 21 also displays the history on the chat display unit 74.

When the user selects the communication button 72, the application execution unit 21 makes a telephone call to the terminal device of the user with which a chat is to be conducted via the communication server 4. A publicly known conventional method can be used as the mechanism for making the telephone call to the terminal device of the user with which a chat is to be conducted, and therefore, detailed explanation thereabout is omitted.

The keyword display unit 73 displays a matching keyword and a keyword registered as a comment message.

More specifically, when the user with which a chat is to be conducted sees the keyword display unit 73, the user can find which keyword of the keywords registered in advance matches. When the user with which a chat is to be conducted sees the keyword display unit 73, the user can find that someone accesses the user in response to the comment message of the message display unit 63.

Accordingly, this can enhance the chance of smoothly conducting the chat after that.

In the present embodiment, a communication method, a chat, and a communication have been shown as an example, but the present embodiment is not limited thereto, and a fighting game (Othello etc.) may be performed.

Subsequently, the functions of the management server 3 will be explained.

FIG. 8 is a block diagram for illustrating the functions of the management server.

The management server 3 includes a control unit 31 and a storage unit 32.

The control unit 31 performs the processing explained above. More specifically, when the control unit 31 receives the search keyword transmitted by the portable terminal device 2, the control unit 31 determines whether the terminal device of the user matching the condition is present in proximity to the portable terminal device 2. In a case where the terminal device of the user matching the condition is present in proximity to the portable terminal device 2, the control unit 31 transmits the matching information to the portable terminal device 2.

Subsequently, information stored in the storage unit 32 will be explained.

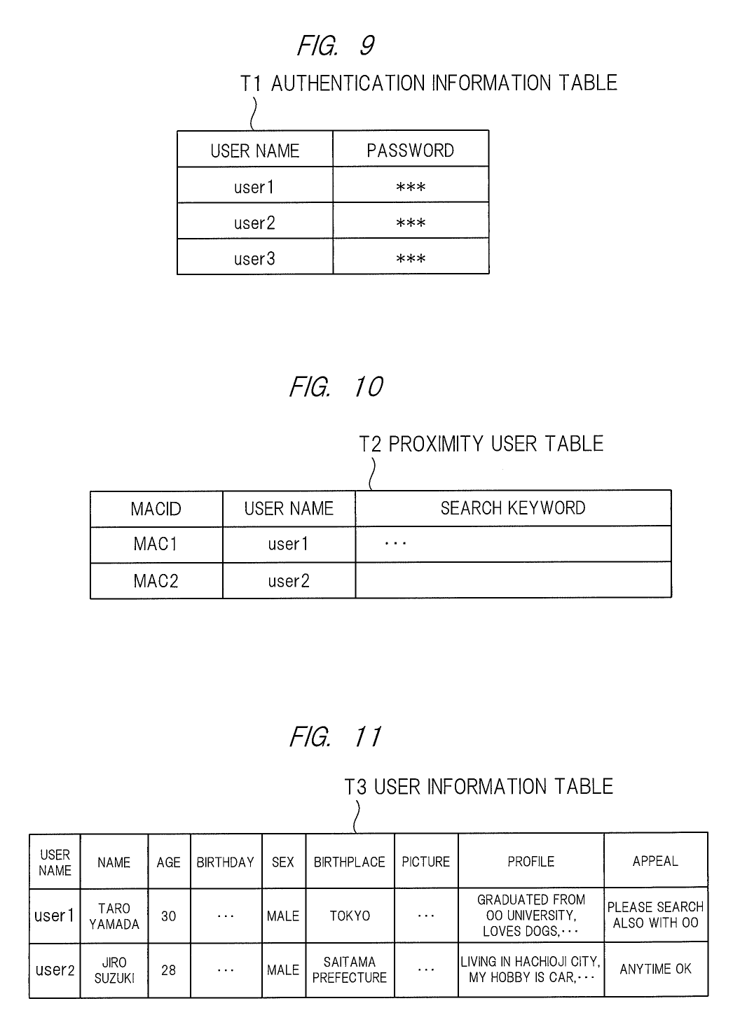

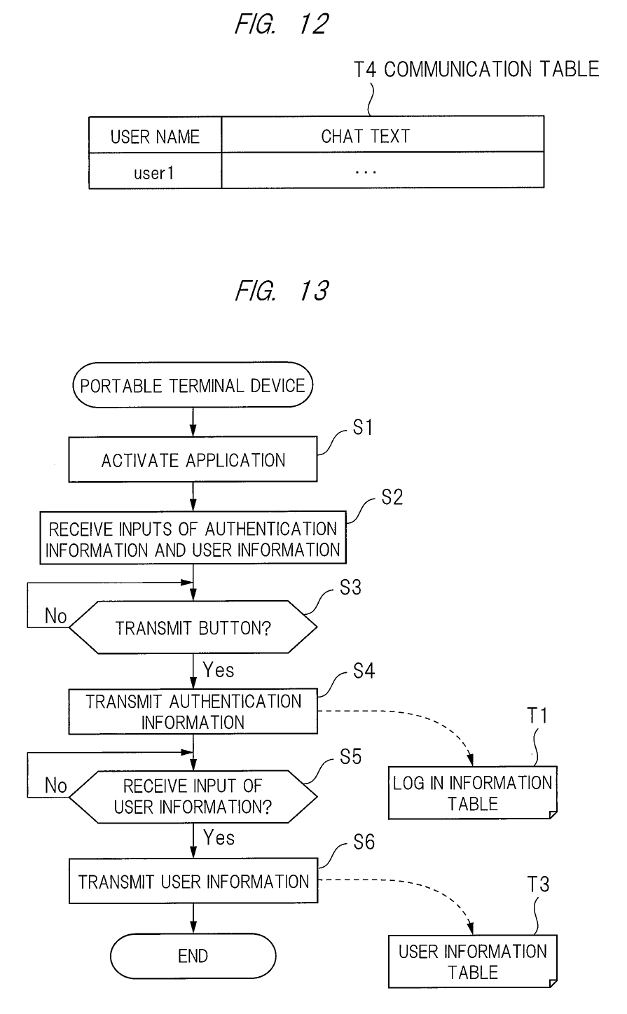

FIG. 9, FIG. 10, FIG. 11, FIG. 12 are figures for explaining information stored in the storage unit.

FIG. 9 is a figure for explaining an authentication information table.

The authentication information table T1 is used when the user logs in to the communication application.

The authentication information table T1 is provided with fields of a user name and a password. Pieces of information arranged in the horizontal direction are associated with each other.

The user names which the user A and the user B registers in advance are set in the fields of the user name.

The passwords which the user A and the user B registers in advance are set in the fields of the password.

FIG. 10 is a figure for explaining a proximity user table.

A proximity user table T2 is a table generated for each user who logs in to this system. For example, when the user A logs in to this system, the proximity user table T2 for the user A is generated. When the user B logs in to this system, a proximity user table T2 for the user B is generated. The proximity user table T2 is an example of a second storage unit.

For example, the proximity user table T2 for the user A is a table used when the user A searches a portable terminal device of a user who is present in proximity to the user A.

The proximity user table T2 is provided with fields for the MAC ID, the user name, and the keyword. Pieces of information arranged in the horizontal direction are associated with each other.

The MAC ID of the terminal device searched by the portable terminal device 2 carried by the user A having logged in to this system is set in the field of the MAC ID.

By the way, the MAC ID is transmitted from the portable terminal device while it is associated with the user name.

The user name associated with the MAC ID that is set in the field of the MAC ID is set in the field of the user name.

The keyword which the user fills in the search keyword input field 55 is set in the field of the keyword.

FIG. 11 is a figure for explaining a user information table.

Information about the user himself or herself which the user who logs in to the communication application registered in advance is stored in the user information table T3. The user information table T3 is an example of the first storage unit.

Fields for user name, name, age, birthday, sex,

birthplace, picture, and profile are provided in the user information table T3. Pieces of information arranged in the horizontal direction are associated with each other.

The content of the user information table T3 can be, for example, newly registered and modified by using a user information registration screen (not shown) and the like executed by the application execution unit 21.

The user ID of the user is set in the field of the user name.

The real name, a nickname, and the like of the user is set in the field of the name.

The age of the user is set in the field of the age.

The birthday of the user is set in the field of the birthday.

The sex of the user is set in the field of the sex.

The birthplace of the user is set in the field of the birthplace.

A picture which is displayed in the picture display unit 51 and which another person displays in the picture display unit 61 of the matching screen 6 is set in the field of the picture.

A keyword and the like desired to be matched when another person inputs a search keyword is set in the field of the profile.

An appeal text which the user wants to be displayed on the message display unit 63 is set in the field of the appeal.

Subsequently, information stored in the communication server 4 will be explained.

FIG. 12 is a figure for explaining a communication table.

Fields of a user name and a chat text is set in the communication table T4. Pieces of information arranged in the horizontal direction are associated with each other.

The user ID of the user is set in the field of the user name.

A text of a chat and information about a person with whom the user talks are set in the field of the chat text.

Subsequently, the processing of the communication support system 1 will be explained with reference to a flowchart. First, pre-processing for allowing the user to logs in to the system will be explained.

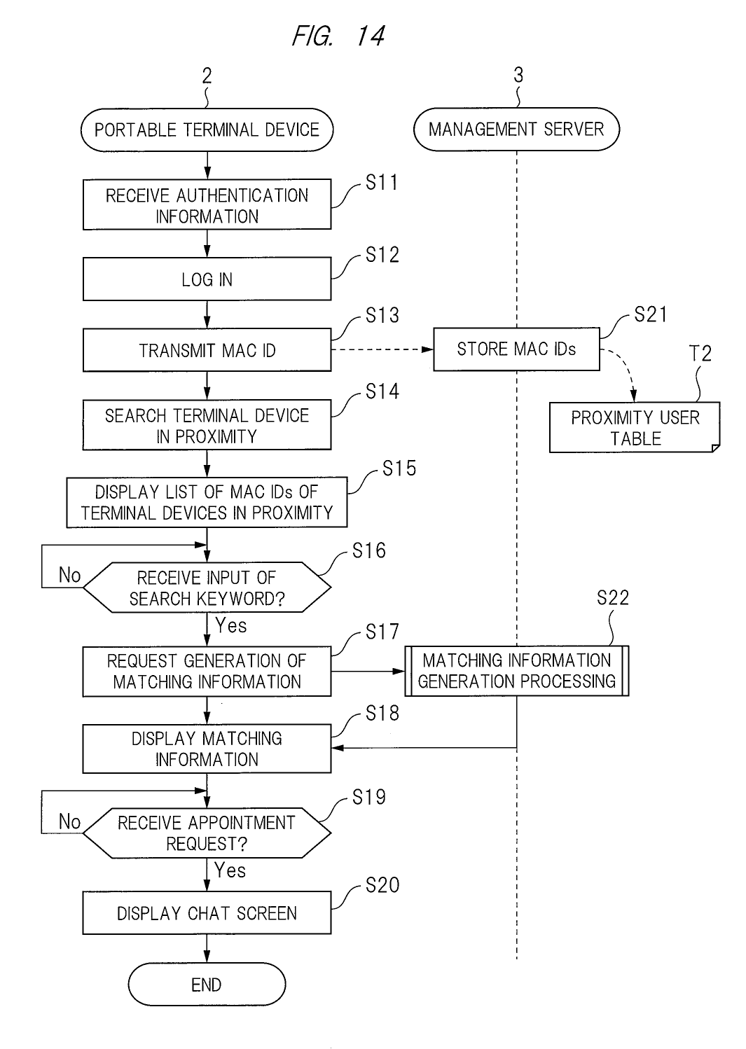

FIG. 13 is a flowchart for explaining pre-processing.

[Step S1] When the user touches an icon for activating an application displayed on the display 104a, the communication application is activated.

[Step S2] The application execution unit 21 receives inputs of authentication information (user name and password) and user information. The input of the user information is arbitrary.

[Step S3] The application execution unit 21 determines whether a transmission button is pressed down or not. In a case where the transmission button is pressed down (Yes in step S3), step S4 is subsequently performed. In a case where the transmission button is not pressed down (No in step S3), the application execution unit 21 waits for a pressing down of the transmission button.

[Step S4] The application execution unit 21 transmits the authentication information to the management server 3. The management server 3 stores the received authentication information to the authentication information table T1.

[Step S5] The application execution unit 21 determines whether an input of user information is received or not. In a case where an input of user information is received (Yes in step S5), step S6 is subsequently performed. In a case where an input of user information is not received (No in step S5), the processing as illustrated in FIG. 9 is terminated.

[Step S6] The application execution unit 21 transmits the user information to the management server 3. The management server 3 stores the received user information to the user information table T3.

The explanation about FIG. 13 ends here.

Subsequently, the processing performed when the user actually tries to perform communication will be explained.

FIG. 14 is a flowchart for explaining processing of a portable terminal device according to an embodiment.

### (Processing of Portable Terminal Device)

[Step S11] When the user activates the communication application, the application execution unit 21 receives the authentication information.

[Step S12] When the application execution unit 21 receives the authentication information, the application execution unit 21 transmits the authentication information to the management server 3. When the management server 3 determines that the authentication information received by the user is correct, the communication application is logged in. Thereafter, step S13 is subsequently performed.

[Step S13] The application execution unit 21 transmits the MAC ID of the portable terminal device 2 to the management server 3 in association with the user name of the user who has logged in. Thereafter, step S14 is subsequently performed.

[Step S14] According to a command of the application execution unit 21, the short distance communication execution unit 22 obtains a list of MAC IDs of portable terminal devices capable of performing short distance communication via Bluetooth (registered trademark). Thereafter, step S15 is subsequently performed.

[Step S15] The application execution unit 21 uses a search result of the short distance communication execution unit 22 to display a list of MAC IDs of terminal devices in the proximity on the display 104a.

[Step S16] The application execution unit 21 determines whether a search keyword is input to the search keyword input field 55 and the search start button 56 is pressed down or not. In a case where a search keyword is input and the search start button 56 is pressed down (Yes in step S16), step S17 is subsequently performed. In a case where the search start button 56 is not pressed down (No in step S16), the application execution unit 21 waits for a press down of the search start button 56.

[Step S17] The application execution unit 21 transmits a generation request of matching information to the management server 3.

[Step S18] When matching information generated by the management server 3 is received, the application execution unit 21 displays the matching information on the display 104a.

[Step S19] The application execution unit 21 determines whether an appointment request by the user is received or not. In a case where the appointment request is received (Yes in step S19), step S20 is subsequently performed. In a case where the appointment request is not received (No in step S19), the application execution unit 21 waits for the appointment request.

[Step S20] The application execution unit 21 displays a chat screen 7 obtained by accessing the communication server 4 on the display 104a.

The explanation about FIG. 14 ends here.

When the portable terminal device 2 receives an input of a search keyword, and every time the re-search start button 65 is pressed down, repeatedly executes the processing after step S16.

In the present embodiment, a list of MAC IDs of terminal devices in proximity is displayed in step S15. However, the present invention is not limited thereto. For example, a list of MAC IDs of terminal devices in proximity may not be displayed until a search keyword is received.

Although not shown in the drawings, in a case where the search start button 56 is pressed down when a search keyword is not input into the search keyword input field 55, a list of MAC IDs of terminal devices in proximity may be displayed, and in a case where the search start button 56 is pressed down when a search keyword is input, the matching screen 6 may be displayed.

Subsequently, the processing of the management server 3 will be explained.

### (Processing of Management Server)

[Step S21] The management server 3 stores, into the proximity user table T2, the MAC ID and the user name of the portable terminal device 2 received.

[Step S22] When the management server 3 receives a matching information generation request, processing for generating matching information (matching information generation processing) is executed. The management server 3 transmits the generated matching information to the portable terminal device 2.

Subsequently, the matching information generation processing of step S22 will be explained with reference to a flowchart.

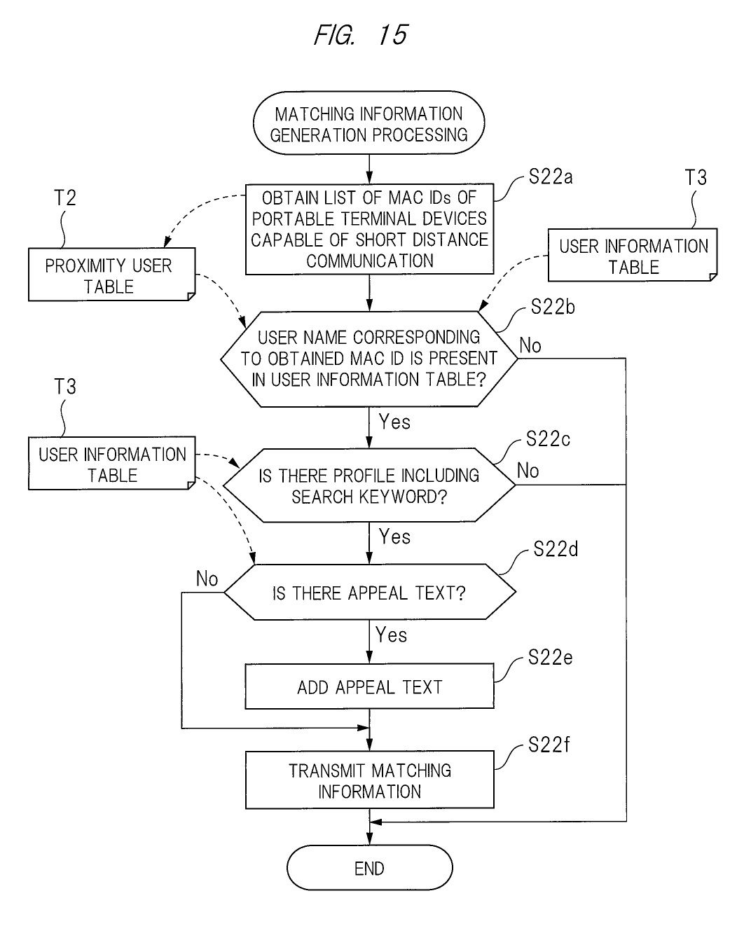

FIG. 15 is a flowchart for explaining the matching information generation processing.

[Step S22a] The management server 3 receives a list of MAC IDs of terminal devices capable of performing short distance communication. Thereafter, step S22b is subsequently performed.

[Step S22b] The management server 3 determines whether a user name corresponding to the list of MAC IDs obtained in step S22a (hereinafter referred to as a corresponding user name) exists in the user information table T3 or not. In a case where the corresponding user name exists in the user information table T3 (Yes in step S22b), step S22c is subsequently performed. In a case where the corresponding user name does not exist in the user information table T3 (No in step S22b), the processing as illustrated in FIG. 13 is terminated.

[Step S22c] The management server 3 refers to the field of the profile of the corresponding user name in the user information table T3. Then, a determination is made as to whether the profile matching the search keyword in step S22b is set in the field of the profile of the corresponding user name. In a case where the profile matching the search keyword in step S22b is set in the field of the profile of the corresponding user name (Yes in step S22c), step S22d is subsequently performed. In a case where the profile matching the search keyword in step S22b is not set in the field of the profile of the corresponding user name (No in step S22c), the processing as illustrated in FIG. 15 is terminated.

The method of search of the profile matching the search keyword can use a publicly known conventional algorithm such as exact match and partial match.

[Step S22d] The management server 3 determines whether an appeal text is set in the field of the appeal of the corresponding user name in the user information table T3. In a case where an appeal text is set in the field of the appeal of the corresponding user name (Yes in step S22d), step S22e is subsequently performed. In a case where an appeal text is not set in the field of the appeal of the corresponding user name (No in step S22d), step S22f is subsequently performed.

[Step S22e] The management server 3 adds an appeal text to the matching information. Thereafter, step S22f is subsequently performed.

[Step S22f] The management server 3 transmits the matching information to the portable terminal device 2. Thereafter, the matching information generation processing is terminated.

As described above, according to the communication support system 1 of the present embodiment, a search keyword can be determined in real time, and therefore, the keyword can be determined freely in accordance with the feeling of the user at that moment. The comment message is displayed on the message display unit 63, so that this can enhance the chance that the users can communicate with each other.

The processing performed by the management server 3 can be processed in a distributed manner by multiple apparatuses.

### <Modification>

A digital signage can be applied to the communication support system 1. The digital signage is an advertising medium for displaying video and information by using a flat display and a projector by making use of digital technique for display and communication.

More specifically, when the short distance communication execution unit 22 obtains the MAC ID of the digital signage when the short distance communication execution unit 22 obtains the MAC IDs of terminal devices which are present in proximity to the portable terminal device 2 by using Bluetooth (registered trademark), the management server 3 obtains, on the basis of the obtained MAC ID, advertisement information about an advertisement content from a storage device storing various kinds of advertisement information displayed on a digital signage present in proximity to the portable terminal device 2. Then, the management server 3 displays the obtained information at a portion of the matching screen 6, for example, a content attached to the advertisement displayed on the digital signage (for example, an icon and the like having an image (image data) obtained by cropping a part of the advertisement content displayed on the digital signage). This icon is associated with a predetermined URL (for example, a URL describing a product of sales target), and when the user selects an icon, the content of the URL is displayed on the display 104a.

The management server 3 has a function of counting accesses to the URL from the advertisement displayed on the matching screen 6, and for example, in accordance with the number of counts, a predetermined amount of money is paid from an advertisement company to the management company of the management server 3.

According to the modification, the digital signage is adopted as the source of transmission of the advertisement, but the modification is not limited thereto. For example, a portable terminal device carried by an advertisement sales person may be the source of transmission of the advertisement. The portable terminal device carried by this advertisement sales person stores data of advertisement displayed on a portion of the matching screen 6. In this case, the display 104a displays an advertisement alone (push sales). An advertisement as well as the user name of the portable terminal device carried by the advertisement sales person are displayed. The advertisement sales person preferably stores, for example, information capable of identifying the appearance of himself or herself in a comment message.

For example, on the basis of type information (class information) about Bluetooth (registered trademark), the type (for example, earphone, smart phone, portable terminal, PC) and the like of the terminal device is identified, and an advertisement according to the identified device may be displayed. For example, when the device is an earphone, music related, a newly released earphone, and the like is displayed as an advertisement. Further, an advertisement of audio, which is a superordinate conception thereof, may be displayed. In another example, when the device is a game, a newly-released game and an advertisement about a toy, which is a superordinate conception thereof, may be displayed.

The short distance communication may be a communication using microwave.

In the present embodiment, the short distance communication is used as the means for communicating. However, the present embodiment is not limited thereto. When short distance communication cannot be performed with each other, the portable terminal device may be configured to notify the user.

The server apparatus, the program, the data transmission and reception method, and the terminal device according to the present invention have been hereinabove explained with reference to embodiments shown in the drawings, but the present invention is not limited thereto. The configuration of each unit can be replaced with one having the same function and having any given configuration. Also, any other constituent elements and steps may be added to the present invention.

The present invention may be a combination of two or more constituent elements (features) of the embodiments described above.

The above processing function may be realized by a computer. In this case, a program describing a processing content of a function possessed by the portable terminal device 2 is provided. When the program is executed by a computer, the processing function is realized by the computer. The program describing the processing content can be recorded on a recording medium that can be read by the computer. Recording media that can be read by the computer include a magnetic storage device, an optical disk, an optical magnetic recording medium, a semiconductor memory, and the like. Magnetic storage devices include a hard disk drive, a flexible disk (FD), a magnetic tape, and the like. Optical disks include DVD, DVD-RAM, CD-ROM/RW, and the like. Optical magnetic recording media include a Magneto-Optical disk (MO), and the like.

When the program is circulated, for example, movable recording media such as DVD and CD-ROM recorded with the program are sold. The program may be stored to a storage device of a server computer, and the program may be transferred from the server computer to another computer via a network.

The computer executing the program stores, for example, a program recorded in a movable recording medium or a program transferred from a server computer, into a storage device of the computer. Then, the computer reads the program from the storage device of the computer itself, and executes the processing according to the program. The computer may directly read the program from the movable recording medium, and may execute the processing according to the program. The computer can successively execute the processing according to the received program every time a program is transferred from the server computer connected via the network.

At least some of the processing functions may be realized by electronic circuits such as Digital Signal Processor (DSP), Application Specific Integrated Circuit (ASIC), and Programmable Logic Device (PLD).

What is claimed is:

1. A server apparatus comprising:
a first storage unit that stores user identification information and user information about a user in association with each other;
a second storage unit that stores, for each user, identification information about a portable terminal device carried by a first user and identification information about a terminal device of a second user located in proximity to the first user obtained from short distance communication using Bluetooth (registered trademark);
an extraction unit that receives identification information about a terminal device capable of performing the short distance communication by using Bluetooth (registered trademark), refers to the first storage unit and the second storage unit, and extracts user information about a keyword from the first storage unit when the extraction unit receives the keyword with which a predetermined user is searched from the portable terminal device carried by the first user; and
a display unit that causes a display of the portable terminal device carried by the first user to display the extracted user information.

2. The server apparatus according to claim 1, wherein the user information includes a message which is notified to a user who inputs the keyword, and the display unit causes a display of the portable terminal device carried by the first user to display the message.

3. The server apparatus according to claim 2, wherein image data attached to the message displayed on the display is displayed.

4. The server apparatus according to claim 1, wherein the display unit causes the display of the portable terminal device carried by the first user to display the keyword.

5. A program for a computer including:
a first storage unit that stores user identification information and user information about a user in association with each other;
a second storage unit that stores, for each user, identification information about a portable terminal device carried by a first user and identification information about a terminal device of a second user located in proximity to the first user obtained from short distance communication using Bluetooth (registered trademark),
wherein the computer is caused to execute processing of:
when a keyword with which a predetermined user is searched from the portable terminal device carried by the first user is received, identification information about a terminal device capable of performing the short distance communication by using Bluetooth (registered trademark) is received, and user information about the keyword is extracted from the first storage unit by referring to the first storage unit and the second storage unit, and
the extracted user information is displayed on a display of the portable terminal device carried by the first user.

6. A data transmission and reception method for a computer including
a first storage unit that stores user identification information and user information about a user in association with each other;
a second storage unit that stores, for each user, identification information about a portable terminal device carried by a first user and identification information about a terminal device of a second user located in proximity to the first user obtained from short distance communication using Bluetooth (registered trademark),
wherein the computer is caused to execute processing of:
when a keyword with which a predetermined user is searched from the portable terminal device carried by the first user is received, identification information about a terminal device capable of performing the short distance communication by using Bluetooth (registered trademark) is received, and user information about the keyword is extracted from the first storage unit by referring to the first storage unit and the second storage unit, and
the extracted user information is transmitted to the portable terminal device carried by the first user,
wherein the portable terminal device transmits the keyword, and
displays the user information transmitted by the computer on the display.

7. A server apparatus comprising:
a first storage unit that stores user identification information and user information about a user in association with each other;
a second storage unit that stores, for each user, identification information about a portable terminal device carried by a first user and identification information about a terminal device located in proximity to the first user obtained from short distance communication using Bluetooth (registered trademark);
an obtaining unit that obtains advertisement information about an advertisement content from a storage device storing various kinds of information for advertisement displayed on the obtained digital signage when a digital signage is included in the terminal device stored in the second storage unit; and
a display unit that causes a display of the portable terminal device carried by the first user to display the obtained advertisement information together with the user information.

8. A server apparatus comprising:
a first storage unit that stores user identification information and user information about a user in association with each other;
a second storage unit that stores, for each user, identification information about a portable terminal device carried by a first user and identification information about a terminal device of a second user located in proximity to the first user obtained from short distance communication;
an extraction unit that receives identification information about a terminal device capable of performing the short distance communication, refers to the first storage unit and the second storage unit, and extracts user information about a keyword from the first storage unit when the extraction unit receives the keyword with which a predetermined user is searched from the portable terminal device carried by the first user; and
a display unit that causes a display of the portable terminal device carried by the first user to display a screen including the extracted user information and for starting communication between the first user and the second user via the portable terminal device of the first user and the portable terminal device of the second user.

9. The server apparatus according to claim 8, wherein the user information includes a message which is notified to a user who inputs the keyword, and the display unit causes a display of the portable terminal device carried by the first user to display the message.

10. The server apparatus according to claim 9, wherein image data attached to the message displayed on the display is displayed.

11. The server apparatus according to claim 8, wherein the display unit causes the display of the portable terminal device carried by the first user to display the keyword.

12. A program for a computer including:
a first storage unit that stores user identification information and user information about a user in association with each other;
a second storage unit that stores, for each user, identification information about a portable terminal device carried by a first user and identification information about a terminal device of a second user located in proximity to the first user obtained from short distance communication,
wherein the computer is caused to execute processing of:
when a keyword with which a predetermined user is searched from the portable terminal device carried by the first user is received, identification information about a terminal device capable of performing the short distance communication is received, and user information about the keyword is extracted from the first storage unit by referring to the first storage unit and the second storage unit, and
a display of the portable terminal device carried by the first user is caused to display a screen including the extracted user information and for starting communication between the first user and the second user via the portable terminal device of the first user and the portable terminal device of the second user.

13. A data transmission and reception method for a computer including
a first storage unit that stores user identification information and user information about a user in association with each other;
a second storage unit that stores, for each user, identification information about a portable terminal device carried by a first user and identification information about a terminal device of a second user located in proximity to the first user obtained from short distance communication,
wherein the computer is caused to perform:
when a keyword with which a predetermined user is searched from the portable terminal device carried by the first user is received, identification information about a terminal device capable of performing the short distance communication is received, and user information about the keyword is extracted from the first storage unit by referring to the first storage unit and the second storage unit, and
a screen including the extracted user information and for starting communication between the first user and the second user via the portable terminal device of the first user and the portable terminal device of the second user is transmitted to the portable terminal device carried by the first user, and
wherein the portable terminal device transmits the keyword, and
displays the user information transmitted by the computer on the display.

14. A server apparatus comprising:
a first storage unit that stores user identification information and user information about a user in association with each other;
a second storage unit that stores, for each user, identification information about a portable terminal device carried by a first user and identification information about a terminal device located in proximity to the first user obtained from short distance communication;
an obtaining unit that obtains advertisement information about an advertisement content from a storage device storing various kinds of information for advertisement displayed on the obtained digital signage when a digital signage is included in the terminal device stored in the second storage unit; and
a display unit that causes a display of the portable terminal device carried by the first user to display the obtained advertisement information as an icon associated with a predetermined URL.

15. The server apparatus according to claim 8, wherein the short distance communication uses Wireless Fidelity (Wi-Fi).

16. The server apparatus according to claim 14, wherein the short distance communication uses Wireless Fidelity (Wi-Fi).
